(19) United States
(12) Patent Application Publication
(10) Pub. No.: US 2012/0239581 A1
(43) Pub. Date: Sep. 20, 2012

(54) SCALABLE METHOD AND SYSTEM FOR CONNECTING, TRACKING AND FACILITATING WARRANTY, MAINTENANCE, SERVICE AND REPLACEMENT OF PRODUCTS WITHIN A COMMUNITY OF RESIDENTIAL HOUSING AND/OR COMMERCIAL BUILDING INVENTORIES OR UNITS OVER A COMMUNICATIONS NETWORK

(76) Inventor: Doyle W. Mosher, Birmingham, MI (US)

(21) Appl. No.: 13/047,036

(22) Filed: Mar. 14, 2011

(51) Int. Cl. G06Q 10/00

(52) U.S. Cl. 705/302; 705/305; 705/303

(57) ABSTRACT

A scalable method and system are provided for connecting, tracking and facilitating warranties, recalls, maintenance, repair and upgrade/replacement and purchase of new products within a community of large-scale, homogeneous building inventories (LSHBI) or units over a communications network. The method includes providing a database of electronic data at a computer site. The data includes building product data that uniquely identifies building products common to and contained within each housing unit in a community of subscribing building units. The electronic data also includes service provider data that identifies service providers for the building products and warranty data that identifies warranties and warranty dates for at least one of the building products and services provided by the service providers. The method further includes analyzing the electronic data to determine whether an action to facilitate the maintenance, repair or replacement of at least one building product is to be performed.

### BACKGROUND

1. Field of the Invention

This invention relates to methods and systems for connecting, tracking and facilitating; warranties, recalls, maintenance, service, upgrade/replacement or purchase, of all products within large-scale homogeneous building inventories (LSHBI) or units. These inventories are identified as multiple building units which were constructed with identical products and/or include all furniture, fixtures and equipment which are also identical products. These inventories will include, but not be limited to, single-family homes, condominiums, town homes, apartments, retail chains, restaurant chains, hotel and motel chains, like commercial buildings, etc. The platform that will be used to connect, track and facilitate the product data, subscribers and common conduits, will be a communications network such as the internet.

2. Background Art

Warranties, recalls, maintenance, service and upgrade/replacement and new purchases of products has become increasingly important post building boom. The connectivity chain of builders/developers, subcontractors/suppliers and manufacturers/wholesalers to end consumers has been significantly damaged due to the real estate collapse. The end consumer is left with rising product problems, many products of which were not branded therefore difficult to identify, and loss of connectivity leaving consumers frustrated and concerned for who to contact. Concurrently, the remaining majority of subcontractors/suppliers as well as manufacturers/wholesalers have lost their conduit (builders whose businesses failed) which connected, educated, promoted and managed their relationship with end consumers causing significant loss of business and a need to redefine their place in the market.

Published U.S. patent application 2007/0033108 discloses a system for collecting, maintaining, and using information about construction, maintenance, and use features of buildings and their components. One or more building identifier tags affixed to a building during construction include a unique building identifier for the building and access information allowing a user to access a computer-implemented repository of information about the building. The repository may comprise information about components in the building, which may be identified in the repository by product identifiers, as well as information about component manufacturers, warranties, installation and maintenance instructions, information about workers associated with construction of the building, and quality checkpoints useful for checking and documenting the quality of construction for the building. The repository may also facilitate registration of warranties, transmission of safety and recall information associated with building components, targeted marketing of offers to residents of the building, as well as other communications amongst parties associated with the building.

Other published U.S. patent applications related to the field of the present invention include: 2006/0095289; 2004/0236619; 2004/0098279; 2003/0061104 and 2002/0129001.

The following websites are related to the field of the present invention:

1) ServiceMagic (www.servicemagic.com) helps homeowners locate service professionals for home repair and maintenance help. ServiceMagic

2) HomeSpot (www.homespothg.com) provides custom maintenance lists, notes, and product information.

3) Interaction Community Systems (ICS) (www.interactioncs.com) is for property managers based on number of units. Many features for communities:
eGarage sales
Bulletin boards
voting
member directories
event calendars
maintenance requests
vendor lists with ratings and reviews

4) Pro Home Manager (www.prohomemanager.com) is useful for individual homeowners or people managing a few properties. Its focus is on managing a list of products in the house and keeping up on maintenance tasks.

5) Angie's List (www.angieslist.com) provides member-created reviews of local businesses. It also provides a third party dispute resolution for consumers who have problems when dealing with a business. Its focus is on providing information on service providers.

6) Reply.com (www.reply.com) is a marketplace for buying and selling leads. Service providers can bid on leads that other people or companies collect. They focus on leads for automotive, real estate and home improvement businesses.

### SUMMARY

There is not presently a single platform that proactively and comprehensively addresses, products, product data, product manufacturers, supply and service chains and various conduits to the end consumer within LSHBI. As described herein in the Detailed Description, HomeDash™ is one embodiment of a scalable method and system providing connection, tracking and facilitating of warranties, recalls, maintenance, service and upgrade/replacement and new products for subscribers within LSHBI using a communications network such as the internet.

The method includes providing a database of electronic data at a computer site. The data includes product data, service provider data, and warranty data. The product data uniquely identifies building products common to and contained within each building unit within a LSHBI of subscribing units. The service provider data identifies service providers for the products and the warranty data identifies warranties and warranty dates for the products.

The product data may include information or information source identifiers that identify manufacturers, suppliers and/or authorized service providers for products commonly contained within and between each building unit. The products may include but not be limited to, one of the following categories: appliances, audio/video, cabinetry, closets, countertops, doors, drywall, electrical fixtures, exterior veneers, hardware, heating and cooling systems, insulation, electrical fixtures, fireplaces, flooring, foundations, mirrors and glass, painting, patio and decking, plumbing fixtures, security, stairs, roofing and gutters, waterproofing, windows and exterior doors and all furniture, fixtures and equipment. The product data may include a schedule of warranties and maintenance dates for the products contained within each subscribing building unit. In addition, the product data may include information or information source identifiers sufficient to enable upgrade/replacement and new products to be viewed on a device. Also, the product data may include a recall for a products contained within each subscribing building unit. Furthermore, the product data may include communication information that allows subscribers to communicate with resellers, recyclers and charities for transfer of products.

The electronic data may include rating data that represents ratings of the service and product suppliers. Furthermore, the electronic data may include tracking data. The tracking data indicates whether the performance of the products or service are less than optimal and unacceptable.

The method further includes analyzing the electronic data to determine whether an action to facilitate the maintenance, repair or replacement of at least one product is to be performed.

The step of analyzing may include determining a substantially common warranty date for one of the products. The action may include at least one of adding and modifying data in the database. Furthermore, the action may be removing a rated service provider from the database if the ratings associated with the rated service provider are less than optimal and unacceptable. In addition, the action may be generating a lead and communicating the lead to a supplier of goods or services. Also, the action may be communicating an alert to a device for notifying a warranty expiration, a recall notice, a maintenance date, and/or a product update for products contained within each subscribing building unit.

The step of analyzing may be performed to determine whether an original supplier of the products or services for the products remains in the business of supplying the products or services, respectively, and the action may be removing the original supplier or service provider from the database and substituting a replacement supplier or service provider for the original supplier or service provider. Furthermore, the step of analyzing may be performed statistically.

The service suppliers may be authorized service providers (manufacturer specific). Furthermore, the service suppliers may be local service providers (general providers of goods and services, i.e. a carpenter or a lumberyard). In addition, the service suppliers may comprise of at least one of insurance, mortgage and whole house/building warranty companies. Also, the service suppliers may include companies associated with extending the warranties of specific products. In addition, the service suppliers may include charities or recyclers of products.

The service suppliers may include but not be limited to one of the following categories: appliances, audio/video, cabinetry, carpentry, closets, countertops, deck, doors, drywall, electrical, excavation, exterior veneers, fireplaces, flatwork, flooring, foundations, hardware, heating and cooling systems, insulation, mirrors and glass, paint and caulk, patio and paving, plumbing, roofing and gutters, windows and exterior doors, and all furniture, fixtures and equipment.

The communications network may be a computer network and the source identifiers may comprise hyperlinks to home pages accessible via the computer network. Likewise, the communications network may be the Internet and the source identifiers may comprise hyperlinks to home pages accessible via the Internet.

The method may further include receiving at the computer site a request from a subscriber to add personal product data in the database of electronic data. The personal product data may uniquely identify personal products of the subscriber. The personal products may fall into at least one of the categories, but not be limited to: art and collectibles, automobiles, beauty and health, bedding and bath, cell phones, clothes and accessories, computer and electronics, farm and garden, furniture/fixtures and equipment, general, jewelry and watches, office products, musical instruments, recreational vehicles, sporting/exercise, tools and home/building improvement, toys and games, and video gaming. The computer site may be a website and may comprise a database server. The personal products may be loaded through a portable device (such as a smart phone) scanning of bar codes or could be loaded using swipe cards and/or directly loaded from retailers and other suppliers at point and time of purchase. The personal products may additionally be manually loaded by subscribers into a portable device or at a terminal such as a computer. The subscriber might also upload receipts, photos, warranty cards and all other product related information.

The method may further include providing electronic community information and a forum at a second computer site for subscribers in a community of subscribers to communicate messages between subscribers or with an association or manager of the community. The community information may include directories, online bulletin boards, community news, community calendar and online payment of dues, fees and assessments. Furthermore, the method may further include monitoring use of the computer site that promotes sustainability and best practices by each subscriber and providing a corresponding measurement of the use. The monitored use may include at least one of recycling, donation or resale as well as use of local service providers. The method may further include providing a user interface that allows subscribers to access product and service information for products and services contained within their respective building units. The method may further include a forum for scalable opportunities for subscribers and customers for products & service. Furthermore, the method may include receiving a consent to use the electronic data to convert at least one building unit in the community of building units to be part of the community of subscribing building units.

The method may further include a dashboard. The dashboard may be a landing page displaying an aggregate of gauges, dials, icons, and/or brief written content which allows a subscriber an at-a-glance view to determine overall building health including furniture, fixtures, equipment and/or personal products. The dashboard may include warranties, recalls, maintenance, service, product upgrades/replacement and new purchase, financial transactions (i.e. extended warranties, insurance, mortgage, banking applications, etc.), green footprint, latest expert tips, reward points and/or community updates.

The method may further include rewards points which might be prizes, discounts and/or other incentives encouraging actions from subscribers, communities and/or vendors and customers.

The method may further include sustainable (green) tips, services, products and descriptions of actions which would be considered environmentally prudent. This method may be monitored and represented through gauges and may be tied to reward points, prizes, discounts and other incentives.

The method may further include an expert news section acting as an online magazine, blogs, tips, lists, glossaries, etc.

The method may further include home or building automation/technology and security where subscribers can connect and subscribe to various automation technology and security applications.

The method may further use a mobile device such as a smart phone with applications, including but not limited to, barcode scanning, document scanning and various other loading applications as well as remote access to all functionality within the subscribers website.

A computer system is provided for connecting, tracking and facilitating warranties, maintenance, recalls, service, upgrade/replacement and new purchase of products within a community of units over a communications network. The system includes a database of electronic data at a computer site. The data includes product data that uniquely identifies products common to and contained within each building unit in a community of subscribing building units, service provider data that identifies service providers for the products and warranty data that identifies warranties and warranty dates for at least one of the products and services provided by the service providers. The system further includes a database server for serving up the database of electronic data to a plurality of I/O devices and an engine to analyze the electronic data to determine whether an action to facilitate the maintenance, service or replacement of at least one product is to be performed.

A central community administration body may include, but not be limited to, homeowner's associations, residential and commercial property managers, developers/builders, an owner's representative or an administrative firm managing LSHBI inventories.

A building unit within a LSHBI may include, but not be limited to, a single family home, a condominium, a town home, an apartment, a chain restaurant, a chain retail outlet, a chain hotel-motel, or a chain of commercial buildings, etc.

The above object and other objects, features, and advantages of the present invention are readily apparent from the following detailed description of the best mode for carrying out the invention when taken in connection with the accompanying drawings.

### BRIEF DESCRIPTION OF THE DRAWINGS

FIG. 1 is a schematic environmental view illustrating a computer site or website constructed in accordance with at least one embodiment of the present invention;

FIG. 2 is a schematic diagram illustrating a database server in communication with a website entitled “Home Dash” for serving up a database of electronic data and other information;

FIG. 3 is a schematic diagram illustrating the “HomeDash” website in communication with the database server;

FIG. 4 is a screenshot on a computer display illustrating a number of home services;

FIG. 5 is a screenshot on a computer display illustrating a number of possible home automation alerts;

FIG. 6 is a screenshot on a computer display illustrating a dashboard containing various gauges, dials and icons for home products;

FIG. 7 is an optional screenshot similar to the screenshot of FIG. 6; and

FIG. 8 is a screenshot on a computer display illustrating a partially filled green footprint.

### DETAILED DESCRIPTION OF THE PREFERRED EMBODIMENT(S)

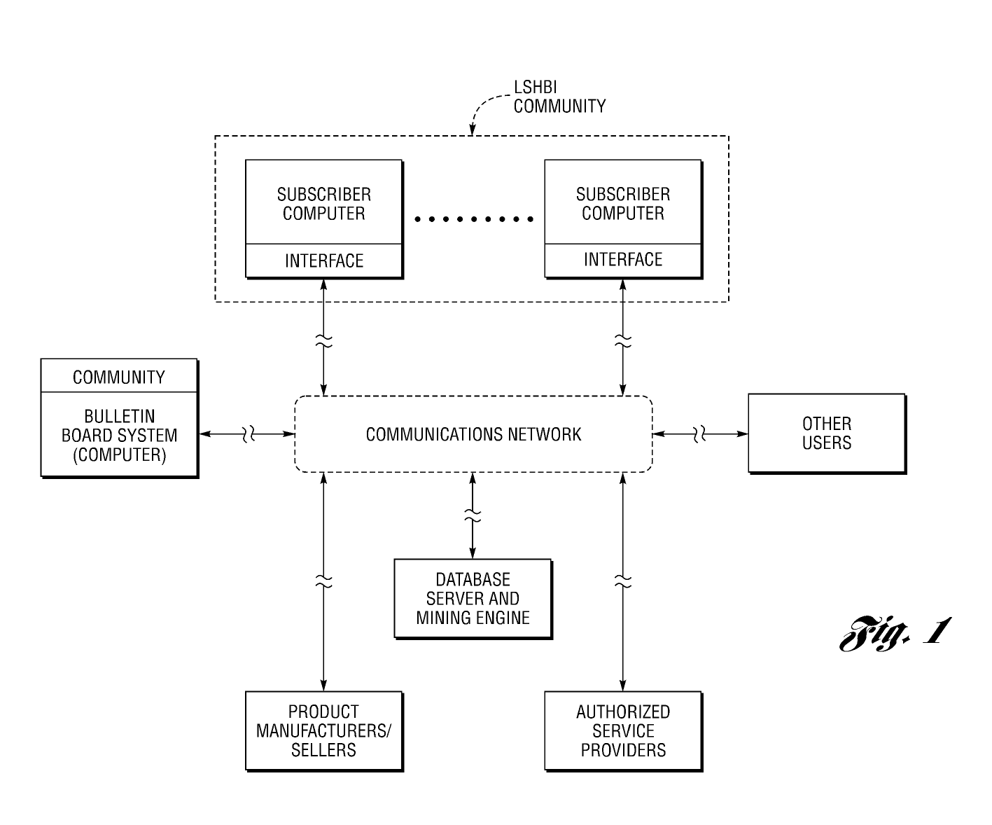

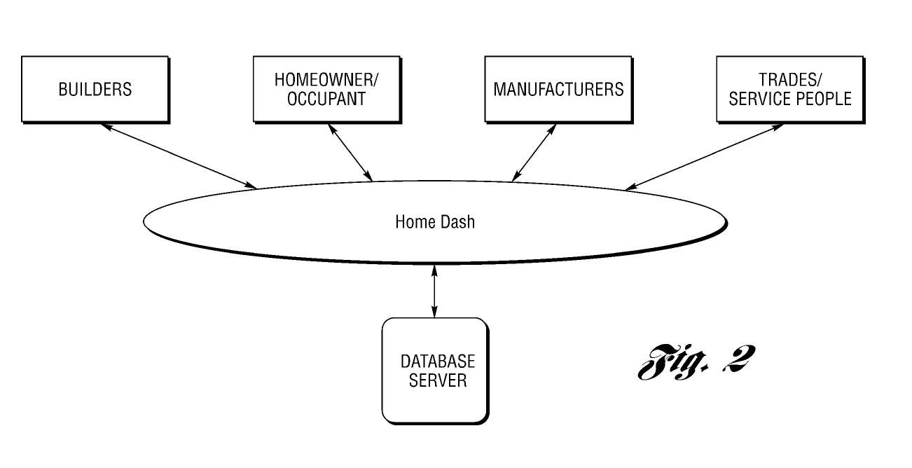

A particular embodiment of the invention is described herein in the form of a method and system called HomeDash™. To implement HomeDash™ the following elements are illustrated in FIG. 1. A computer interface of a computer (or other I/O device) where authorized users (hereinafter subscribers) are able to transmit a request for information and receive information over a communications network. Any network will do such as a computer network like the Internet. The requests are transmitted from the subscriber's interface to a database server. A data mining engine at the server also receives requests to analyze the data in the database, analyzes the data and transmits the resulting analysis or report to the requester over the communications network. Data and information is communicated to and from users through computer interfaces or other means. Each interface is typically provided by a computer program. Each interface may include text input forms and/or graphical elements.

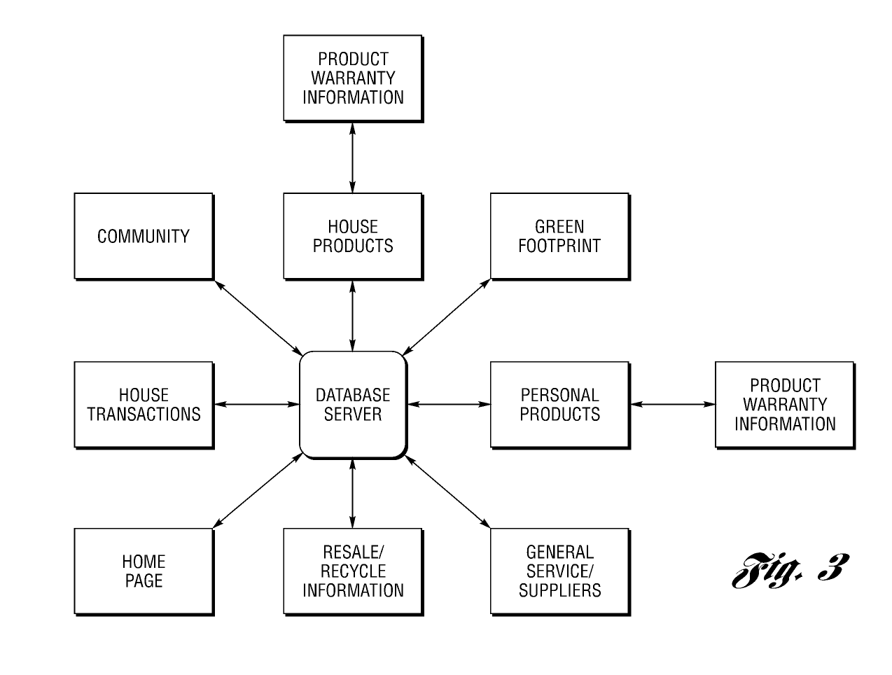

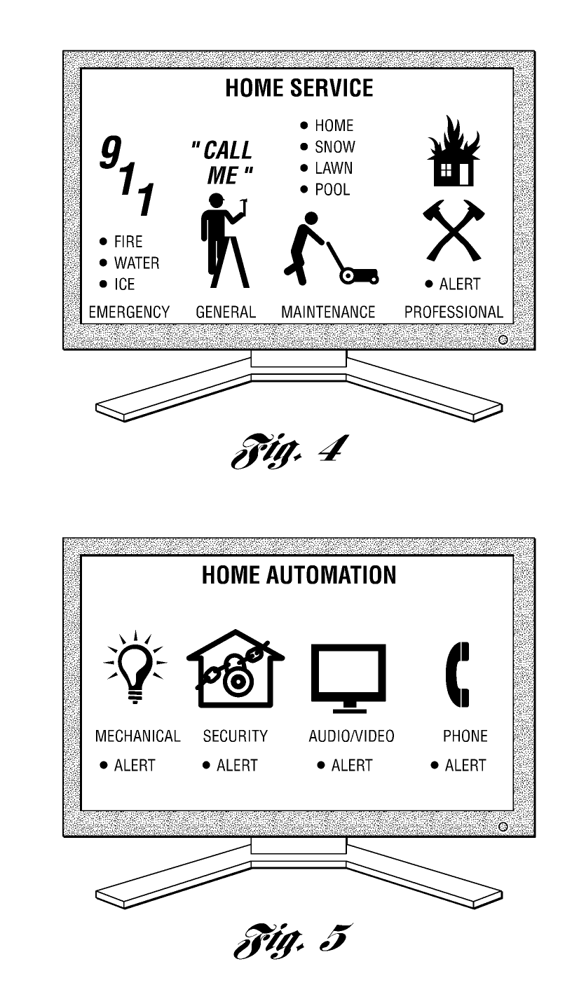

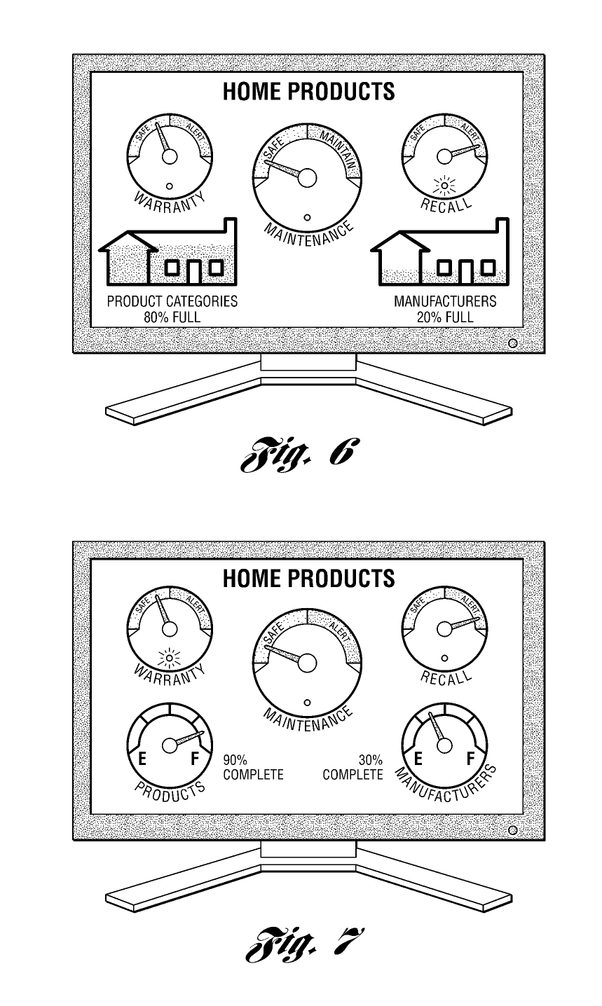

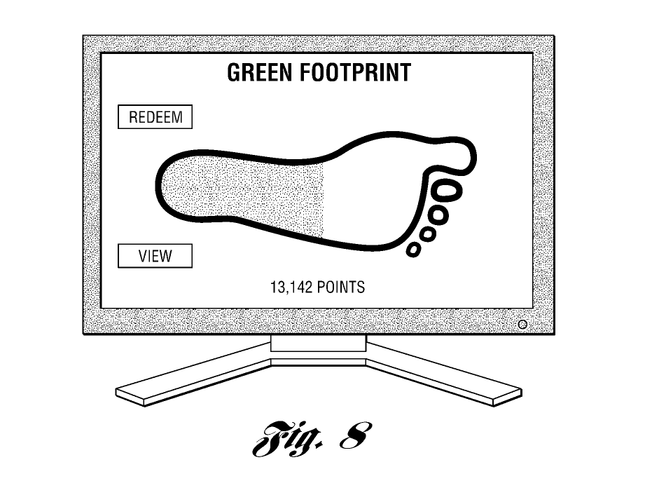

As shown in FIG. 3, HomeDash™ is preferably a website that offers a database and useful data management tools to include but not limited to homeowners, renters, chain retailers, chain hotel-motels, chain restaurants, chain of commercial buildings, property managers and associations, service suppliers, product suppliers, manufacturers, retailers, financial affiliates, and residential or commercial developers or builders. HomeDash™ also generates and communicates sales leads to service and product suppliers so that they may assist in repairs and new purchases as well as finding new customers.

Subscribers are able to enter and organize information on all the products in their building units. They are also able to access up warranty information and maintenance schedules to save money and keep products in top working condition. They will have the ability to look up service providers when they need help repairing or replacing products.

The database of information can be provided by developers of Large Scale Homogeneous Building Inventories (LSHBI) such as Toll Brothers, Centex and Pulte and developers or builders of major retail, restaurant, hotel-motel and commercial building chains. These providers of information may supply HomeDash™ with large blocks of potential customer's build dates and product information data identifying what is in their building units. This allows customer accounts to be pre-populated to make using the site easier for subscribers and to ensure that those subscribers will find product warranty and service provider information in the system.

As Large Scale Homogeneous Building Developers create new developments, they give HomeDash™ the product data within their buildings, and this information is loaded into HomeDash™ database. HomeDash™ allows customers to connect, track and facilitate all warranty, recall, maintenance information and service intervals for everything from their foundation to their roof. When they are in need of warranty, maintenance or service, HomeDash™ offers them easy access to local service providers who are partnered on the site. Once the work is completed, the building owner reviews the contractors and rates them. Contractors with consistently low marks are removed from the site. Should building owners choose to sell their homes or buildings, the building owner can transfer their HomeDash™ account to the new owner, giving them a complete and thorough history on the home or building.

Residential and commercial property managers may use HomeDash™ to organize their day-to-day activities. Reminders let them know when a service interval is nearing, or when a warranty is about to expire. Managers of larger developments find HomeDash™ product tracking capability useful as it generates information on product failure rates. This information allows property managers to make educated decisions when it comes time to maintain and/or replace products within their building units.

HomeDash™ provides both product maintenance tracking and product maintenance lead generation. HomeDash™ is a centralized source for connecting manufacturers, service professionals and building owners with their continuing maintenance and service needs. In other words, HomeDash™ can provide a single source for subscribers to find information for maintaining products, warranties, maintenance and outsourcing their upkeep. The site can track nearly all warranties as well as unique customer profiles providing relevant tracking data that can be managed by the customer and used for generating “leads” for second source partners and manufacturers. The developers of LSHBI generate revenue from leads in their development. Second source partners are able to track data on product failures and warranty issues based on HomeDash™'s database. Extended warranties, insurance, and new mortgages are available for purchase through HomeDash™ and its affiliates. HomeDash™ may sell the rights to partner affiliates, where manufacturers and vendors will be able to message homeowners with relevant products and services.

A variety of users may find it desirable to use HomeDash™. The users goals and needs may vary widely, but the goals and needs center around connecting subscribers with information on identity of products in their buildings, information about those products, and information about warranties and how to maintain, repair and replace those products. For example, these customers may include:
1) Homeowners and Renters (single family, town homes, condominiums and apartments)

These are individuals residing in the houses, town homes, condos and apartments that contain the products that they want to warrant, maintain, service or replace. They will be able to manage the list of products in their building, locate service professionals and manage warranty and maintenance reminders. Their goal is to save money and keep everything in their home in working order. Their biggest concerns are useful information without wasting time.
2) Commercial Building Owners and Renters (retail, restaurant, hotel-motel, commercial buildings)

These are individuals owning, leasing or franchised in buildings that contain the products that they want to warrant, maintain, service or replace. They will be able to manage the list of products in their building, locate service professionals and manage maintenance reminders. Their goal is to save money and keep everything in their home/building in working order. Their biggest concerns are useful information without wasting time.
3) Residential and Commercial Property Managers/Homeowners Associations/Building Owner Representatives

Homeowner's Associations and residential/commercial property managers are looking to connect with subscribers within their community by providing one or more of the following: community directories, on-line bulletin boards, community news, community calendar, online payment of dues, fees and assessments, classifieds, donations and recycling. They are also looking for an efficient conduit to connect their subscribers and themselves to service providers and product manufacturers, to provide warranties, maintenance, recalls and service as well as product upgrades and new products leveraging a scalable opportunity. Their primary concern is continuity and efficiency of communication and finances.

The individuals and organizations responsible for managing and maintaining housing communities, condominiums, apartments, retail chains, hotel-motels chains, restaurant chains and commercial building chains, that contain products that need maintenance, service or replacement. They will be able to manage the list of products in their building units, locate service professionals and manage warranty, recall maintenance, service and new purchases for all of their properties. Their goal is to save time and money and keep everything in their properties in working order. Their biggest concerns are providing useful information quickly, saving them effort and money maintaining their properties and finding service professionals they can count on.

HomeDash™ seeks out large scale property managers to market HomeDash™ as a tool for maintaining their portfolio of business. Residential and commercial property managers are dealing with aging products and maintenance on a much larger scale than a single subscriber. Many property managers oversee properties of different age, often at different locations. HomeDash™ helps property managers keep on track with maintenance, service and replacement of all products in their communities. HomeDash™ gives reminders or alerts whenever warranty, recall, maintenance or service intervals are nearing, allowing property managers to concentrate on their day-to-day work.

HomeDash™ can function as a tool for organizing all warranty, recall maintenance and service for property managers. Warnings or alerts come up when maintenance intervals near, or warranties approach expiration. In large developments or large commercial chains, property managers are able to track failure rates of products and if necessary make changes during replacement.
4) Product Manufacturers (products within LSHBI, furniture, fixtures and equipment, personal products, etc.)

Product manufacturers are looking to make money and service subscribers by branding and selling upgrade, replacement or new products, to include, but not limited to, homeowners, building owners, renters, residential/commercial property managers. Product manufacturers pay for sales leads and advertising in the hope of satisfying existing customers and landing new customers while leveraging a scalable opportunity. Their primary concern is poor customer leads which result in lost time and low financial return.
5) Other Product Manufacturers (all other products)

Generic product manufacturers are looking to make money by branding and selling their products to include but not limited to homeowners, building owners, renters and residential/commercial property managers. They pay for sales leads and advertising in the hopes of satisfying existing customers and landing new customers while leveraging a scalable opportunity. Their primary concern is poor customer leads which result in lost time and low financial return.
6) Local Service Providers (electricians, plumbers, carpenters, etc.)

Local service providers are looking to make money by working for, but not limited to, homeowners, building owners, renters and residential and commercial property managers. They pay for sales leads and advertising in the hopes of servicing existing customers and landing new customers while leveraging a scalable opportunity. Their biggest concern is poor sales leads which result in lost time and low financial return.
7) Local Product Suppliers (electrical supply, plumbing fixtures, lumber, etc.)

Local product suppliers are looking to make money by branding and selling replacement and new products, to include, but not limited to: homeowners, building owners, renters and residential/commercial property managers. Local product suppliers pay for product leads and advertising in the hope of satisfying existing customers and landing new customers while leveraging a scalable opportunity. Their primary concern is poor customer leads which result in lost time and low financial return.
8) Authorized Service Providers (approved service provider per product endorsed by the manufacturer)

Authorized service providers are looking to make money by servicing existing products and/or selling and installing upgrade/replacement or new products, to include, but not limited to homeowners, building owners, renters and residential/commercial property managers. Authorized service providers pay for sales leads and advertising in the hope of satisfying existing customers and landing new customers while leveraging a scalable opportunity. Their primary concern is poor customer leads which result in lost time and low financial return.
9) Extended Warranty Providers

Extended warranty providers are looking to make money by selling their coverage, to include, but not limited to homeowners, building owners, renters and residential/commercial property managers. They pay for sales leads and advertising in the hopes of satisfying existing customers and landing new customers while leveraging a scalable opportunity. Their primary concern is poor customer leads which result in lost time and low financial return.
10) Home Building Automation/Technology/Security

Home and building automation, technology and security companies are looking to make money by branding and selling their services and products, to include, but not limited to, homeowners, building owners, renters and residential/commercial property managers. Building automation, technology and security companies pay for sales leads and advertising in the hopes of satisfying existing customers and landing new customers while leveraging a scalable opportunity. Their primary concern is poor customer leads which result in lost time and low financial return.
11) Insurance Companies

Insurance companies are looking to make money by selling policies to include but not limited to homeowners, renters and commercial building owners on their buildings, personal products, etc. Insurance companies pay for sales leads and advertising in the hopes of satisfying existing customers and landing new customers while leveraging a scalable opportunity. Insurance adjusters are looking to assemble accurate reports of products and aging in order to satisfy claims with minimal dispute. Both are relying on accurate information to qualify leads and produce high financial return.
12) Mortgage Companies

Mortgage companies are looking to make money by selling mortgages to include but not limited to homeowners and building owners. Mortgage companies pay for sales leads and advertising in the hopes of satisfying existing customers and landing new customers while leveraging a scalable opportunity. Their primary concern is poor customer leads and low financial return.
13) Local Charities

Local charities are looking to provide efficiencies by connecting directly to community donated inventories, which list products, aging and condition of subscriber's products to be donated. Charities can match needs with resources minimizing loading and unloading, inventory and time. Their primary concern is efficient distribution of goods.
14) Builders/Developers

Builders/Developers provide a wealth of information on what is in the units they build and their occupants. This provides both product data and potential customers. In return, the builders use the site as a sales incentive for home buyers and the chance to data mine anonymized information gathered and stored in the database as subscribers and property managers use the site.

Builders/developers of LSHBI are a major market targeted by HomeDash™. By first targeting large scale builders/developers, HomeDash™ is able to build a large database of subscriber information quickly. As these new builders finish new developments or identify recently built developments, they are able to offer HomeDash™ as a perk for purchasing a home through their company. The subscriber is then able to use HomeDash™ to manage all of the products and warranty information for all aspects of the home. The builders/developers also find value through HomeDash™'s ability to track product warranty and service intervals. Builders/developers are able to see if a product consistently needs early service or replacement and be able to change to a better performing product, increasing their perceived value. Builders/developers can also connect their local service providers and local suppliers back to the communities they build and/or developed.

Issues related to vendors or service suppliers are immediately documented. HomeDash™ institutes a rating system for all vendors and service suppliers, and any that consistently get poor marks are removed from the site.

HomeDash™ offers both a database for the owner's product information, including warranties, and a list of authorized service providers to offer warranty, maintenance and service capabilities. Subscribers can view their current product information and then contact a specific service professional to get help with product warranty, maintenance and service. HomeDash™ notifies the subscriber, such as through alerts, when warranties are expiring, products are recalled and when scheduled maintenance should occur.

### HomeDash™ Outline of Features:

1. Home/Building Product Identification, by brand of all major products in the home/building—i.e. appliances/cabinets/roofing/windows/etc.
   a. Easy product loading applications with subscriber directed rating system for each product loaded Document scanning (receipts, warranty cards, etc.)
      i. Pre-loaded (community sites)
      ii. Homeowner/building owner/inspector loaded
      iii. Manually load/edit products
      iv. Barcode scanning of new products
   b. Warranty management—schedule of all warranty expiration dates of all major products within the home
      i. Definition of “warranty”
      ii. Product specific tracking of warranty expiration dates per each loaded item
      iii. Alerts (product specific/directly from product supplier) notifying suggested maintenance, upcoming warranty expiration dates, product recalls, product updates, etc.
      iv. Link to all major product(s) websites for warranty information
      v. Connect to multiple authorized service providers, by manufacturer, for all major products within the home/building or added by subscriber
      vi. Connect to alternate manufacturers and authorizes service providers for product manufacturers who are no longer in business
      vii. Guidance on how to work with authorized service providers
      viii. Guidance on what to expect from authorized service providers
      ix. Subscriber can rate authorized service providers on performance, price, or leave general thoughts/comments in rating system
      x. Warranty tips/expert blogging advice
      xi. Ability to extend product warranties
         1. Connect to online extended warranty companies
         2. Online company comparison
         3. Ability to purchase online
   c. Maintenance—proactive prevention—protects products and extends product lifespan
      i. Definition of “maintenance”
      ii. Product specific tracking of suggested scheduled seasonal maintenance per each loaded item
      iii. Alerts (product specific/directly from product supplier) notifying suggested maintenance, upcoming warranty expiration dates, product recalls, product updates, etc.
      iv. Link to all major product(s) websites for maintenance specifications, explanations and schedules
      v. Connect directly to multiple local trades and suppliers
         1. By product (if loaded authorized service)
         2. By category (i.e. appliances, cabinets, windows, etc.) either manufacturer specific or general downloadable by date
         3. By trade (i.e. plumber, electrician, carpenter, etc.)
      vi. Connect to alternate manufacturers and authorizes service providers for product manufacturers who are no longer in business
      vii. Guidance on how to work with local trades and suppliers
      viii. Guidance on what to expect from local trades and suppliers
      ix. Subscriber can rate local trades and suppliers on performance, price, or leave general thoughts/comments in rating system
      x. Maintenance tips/expert blogging advice/product care and cleaning advice/“How To” videos
   d. Manufacturer recalled products
      i. Definition of “recall”
      ii. Alerts (product specific/directly from product supplier) notifying suggested maintenance, upcoming warranty expiration dates, product recalls, product updates, etc.
      iii. Connect to multiple authorized service providers, by manufacturer, for all major products within the home/building or added by subscriber
      iv. Connect to alternate manufacturers and authorizes service providers for product manufacturers who are no longer in business
      v. Guidance on how to work with authorized service providers
      vi. Guidance on what to expect from authorized service providers
   e. Service—reactive—breakage or problem
      i. Definition of “service”
      ii. Connect to multiple authorized service providers, by manufacturer, for service needed for all major products within the home/building or added by subscriber
      iii. Connect to alternate manufacturers and authorizes service providers for product manufacturers who are no longer in business
      iv. Guidance on how to work with authorized service providers, local trades and suppliers
      v. Guidance on what to expect from authorized service providers, local trades and suppliers
      vi. Subscriber can rate local trades and suppliers on performance, price, or leave general thoughts/comments in rating system
      vii. Service tips/expert blogging advice featuring a list of common problems and how to solve or prevent
   f. View replacement/new purchase opportunities of all major products/accessories within the home/building
      i. General definition of replacement, new products, or product enhancement/accessories
      ii. Authorized service or manufactured direct replacement (i.e. replace old Kitchen Aid dishwasher with Kitchen Aid's current model)
      iii. Competitors product replacement with comparative model that “fits” and can replace the original (i.e. replace Kitchen Aid dishwasher with comparable ISE dishwasher)
      iv. Product enhancement or product accessories
      v. “Green” product suggestions (light bulbs, programmable thermostats, etc.)
      vi. Consumers report comparisons to show pricing, quality, warranties, green rating, etc.
      vii. Profiles of the best new products available
      viii. Tips on replacement/expert blogging advice
      ix. Shop online
   g. General information
      i. Glossary of terms
      ii. Ability to scan receipts, warranties and other supporting documents
      iii. List of average product life
      iv. List of quality standards for construction products
   h. Call 1-800 for help with Home Product Identification
2. Personal Products, Furniture, Fixtures & Equipment all other products in your life (i.e. art collectables, TV, lawn & garden, video games, etc.)
   a. Easy product loading applications with subscriber directed rating system for each product loaded Document scanning (receipts, warranty cards, etc.)
      i. Manually load/edit products
         1. For existing personal products
         2. For those without smart phone or portable device capabilities
         3. Option to load photographs, receipts, other supporting documents, etc.
      ii. Barcode scanning of new products
         1. Smart phone or portable device application to provide remote access to all functionality within the subscriber website
         2. Barcode scanning
         3. Automatically inputs pictures of products, receipts, serial number or various other supporting documentation
      iii. Eventually instantly loaded by retailers via subscriber swipe cards or other methods at point and time of purchase
   b. Warranty management—schedule of all warranty expiration dates of all personal products, furniture, fixtures & equipment within the home/building
      i. Definition of “warranty”
      ii. Product specific tracking of warranty expiration dates per each loaded item
      iii. Alerts (product specific/directly from product supplier) notifying suggested maintenance, upcoming warranty expiration dates, product recalls, product updates, etc.
      iv. Link to all major product(s) websites for warranty information
      v. Connect to multiple authorized service providers, by manufacturer, for all major products
      vi. Connect to alternate manufacturers and authorizes service providers for product manufacturers who are no longer in business
      vii. Guidance on how to work with authorized service providers
      viii. Guidance on what to expect from authorized service providers
      ix. Subscriber can rate authorized service providers on performance, price, or leave general thoughts/comments in rating system
      x. Warranty tips/expert blogging advice
      xi. Ability to extend product warranties
         1. Connect to online extended warranty companies
         2. Online company comparison
         3. Ability to purchase online
   c. Maintenance—proactive prevention—protects products and extends product lifespan
      i. Definition of “maintenance”
      ii. Product specific tracking of suggested scheduled maintenance per each loaded item
      iii. Alerts (product specific/directly from product supplier) notifying suggested maintenance, upcoming warranty expiration dates, product recalls, product updates, etc.
      iv. Link to all major product(s) websites for maintenance specifications, explanations and schedules
      v. Connect directly to multiple local trades and suppliers
         1. By product (if loaded authorized service)
         2. By category (i.e. appliances, cabinets, windows, etc.) either manufacturer specific or general downloadable by date
         3. By trade (i.e. plumber, electrician, carpenter, etc.)
      vi. Connect to alternate manufacturers and authorizes service providers for product manufacturers who are no longer in business
      vii. Guidance on how to work with local trades and suppliers
      viii. Guidance on what to expect from local trades and suppliers
      ix. Subscriber can rate local trades and suppliers on performance, price, or leave general thoughts/comments in rating system
      x. Maintenance tips/expert blogging advice/product care and cleaning advice/“How To” videos
   d. Manufacturer recalled products
      i. Definition of “recall”
      ii. Alerts (product specific/directly from product supplier) notifying suggested maintenance, upcoming warranty expiration dates, product recalls, product updates, etc.
      iii. Connect to multiple authorized service providers, by manufacturer, for all major products
      iv. Connect to alternate manufacturers and authorizes service providers for product manufacturers who are no longer in business
      v. Guidance on how to work with authorized service providers
      vi. Guidance on what to expect from authorized service providers
   e. Service—reactive—breakage or problem
      i. Definition of “service”
      ii. Connect to multiple authorized service providers, by manufacturer, for service needed for all major products
      iii. Connect to alternate manufacturers and authorizes service providers for product manufacturers who are no longer in business
      iv. Guidance on how to work with authorized service providers, local trades and suppliers
      v. Guidance on what to expect from authorized service providers, local trades and suppliers
      vi. Subscriber can rate local trades and suppliers on performance, price, or leave general thoughts/comments in rating system
      vii. Service tips/expert blogging advice featuring a list of common problems and how to solve or prevent
   f. View replacement/new purchase opportunities of all major products/accessories within the home
      i. General definition of replacement, new products, or product enhancement/accessories
      ii. Authorized service or manufactured direct replacement
      iii. Competitors product replacement with comparative model and can replace the original
      iv. Product enhancement or product accessories
      v. “Green” product suggestions
      vi. Consumers report comparisons to show pricing, quality, warranties, green rating, etc.
      vii. Profiles of the best new products available
      viii. Tips on replacement/expert blogging advice
      ix. Shop online
   g. General information
      i. Glossary of terms
      ii. Ability to scan receipts, warranties and other supporting documents
      iii. List of average product life
      iv. List of quality standards for construction products
   h. Call 1-800 for help with Personal Product
3. Home/Building Service (not related to home/building or personal products)
   a. Connect with local trades and suppliers—task based as opposed to product based (i.e. plumbers, electricians, painters—or—plumbing suppliers, lighting suppliers, paint stores)
      i. Guidance on how to work with local trades and suppliers
      ii. Guidance on what to expect from local trades and suppliers
      iii. Subscriber can rate local trades and suppliers on performance, price, or leave general thoughts/comments in rating system
   b. Emergency services
      i. Fire, water, ice, theft, etc.
      ii. Service companies (i.e. Belfour, Burton, etc.)
      iii. Trade specific (i.e. sewer backup, plumber, etc.)
      iv. Restoration building companies
      v. Restoration cleaning companies
      vi. Guidance on how to work with emergency service companies
      vii. Guidance on what to expect from emergency service companies
      viii. Subscriber can rate emergency service companies on performance, price, or leave general thoughts/comments in rating system
      ix. Homeowner tips/expert blogging for the steps to take in an emergency
   c. General maintenance services
      i. Lawn, snow removal, pool, landscape, irrigation, “handyman” light maintenance
      ii. Guidance on how to work with general maintenance companies
      iii. Guidance on what to expect from general maintenance companies
      iv. Subscriber can rate general maintenance companies on performance, price, or leave general thoughts/comments in rating system
      v. Tips on general maintenance/expert blogging advice
   d. Professional services
      i. Architects, landscape architects, interior designers, general contractors
      ii. Guidance on how to work with professionals
      iii. Guidance on what to expect from professionals
      iv. Subscriber can rate general professional companies on performance, price, or leave general thoughts/comments in rating system
      v. Tips on selecting a professional company/expert blogging advice
   e. General information
   i. Glossary of terms
   ii. List of quality standards for construction services
   iii. “Green” contractors, subcontractors, professionals, etc.
   f. Call 1-800 for help with Home Service
4. Home/Building Automation technology and security
   a. Definition of “home automation”
   b. Connect to online home automation (i.e. Control 4)
   c. Smart phone or portable device application to provide remote access to all functionality within the subscriber website
   d. Subscriber can rate home automation on performance, price, or leave general thoughts/comments in rating system
   e. Tips on home automation/expert blogging advice
   f. Call 1-800 for help with Home Automation
5. Home/Building Financial budgeting of all home/building related expenses
   a. Electronic storage of all documents, receipts, etc.
   b. Utilities
      i. Manage or track usage
      ii. Ability to pay online
   c. Link directly to insurance companies
      i. Online document listing of home/building and personal products, furniture, fixtures and equipment and their age for insurance premium pricing and accurate cost replacement due to an event
      ii. Online company comparison
      iii. Document scanning
      iv. Ability to purchase online
   d. Link directly to mortgage companies
      i. Same information for appraised value/new mortgage
      ii. Online company comparison
      iii. Document scanning
      iv. Ability to purchase online
   e. Taxes
      i. Document scanning
      ii. Tax records stored per year to be referenced easily
   f. Link to extend product warranty (entire house/building)
      i. Connect to online extended warranty companies
      ii. Online company comparison
      iii. Document scanning
      iv. Ability to purchase online
   g. Miscellaneous home/building documents
      i. Home/building specifications, floor plans, etc.
      ii. Builder supplied directions, information, etc.
      iii. Product receipts, etc.
      iv. Product photographs
   h. Call 1-800 for help with Home Financials
6. Home/Building Care Connect online magazine
   a. Features professional tips/expert blogging advice
   b. Lists including product aging, cleaning, maintenance, services, etc.
   c. Glossary of terms
   d. Call 1-800 for help with Home Care Connect
7. Green Living general or product specific (see replacement, new product or product enhancements/accessories)
   a. Definition of “green”
   b. Fill up your “green footprint” a measurement tool to promote positive choices and measure subscriber performance
   c. Receive “green” tips throughout the website; educating the subscriber to sustainability through product management (best products, best service—resale/recycle communications through the website, use of authorized service providers, local trades and suppliers)
   d. “Green Log”—500 Things Homeowners Can Do
   e. Tips on being “green”/expert blogging advice
   f. Incentives for green actions
   g. Call 1-800 for help with Green Living
8. Dashboard an interactive at-a-glance dashboard
   a. Display through gauges, dials, icons and concise reports for the overall home/building and products health providing quick connectivity and information
9. Rewards and Incentives Program provided through discounts and privileges for subscriber actions
   a. Points tallied per action (i.e. adding products, requesting maintenance services, extending warranties, recycling products, etc.)
   b. Sporadic online prizes offered
   c. Call 1-800 for help with Rewards and Incentives Program
10. Community connection to other Subscribers, Homeowner's Associations and Residential/Commercial Property Managers within LSHBI
   a. Directory of neighbors
   b. Community news
   c. Calendar of events
   d. Alerts of upcoming events
   e. Online payment of dues, fees, assessments, etc.
   f. Check for local deals and special subscriber privileges from local contractors, service providers and supply companies who are offering special conveniences and discounts only to subscribers
   g. Product resale
      i. Community or regional
      ii. Push of a button moves pre-loaded products
      iii. Subscriber can rate sellers, or leave general thoughts/comments in rating system
      iv. Tips on selling/expert blogging
   h. Product donation
      i. Regionally qualified organizations can participate (i.e. Habitat for Humanity, Purple Heart, etc.)
      ii. Push of a button moves pre-loaded products
      iii. Storage of donation receipt for tax purposes
      iv. Subscriber can rate charity organization, or leave general thoughts/comments in rating system
      v. Tips on donating/expert blogging advice
   i. Product recycle
      i. Regional recycle centers located
      ii. Push of a button moves pre-loaded products
      iii. Subscriber can rate recycling center, or leave general thoughts/comments in rating system
      iv. Tips on recycling/expert blogging advice
   j. Call 1-800 for help with Community Connection

### For Major Product Manufacturers:

1. Identify all subscribers who are part of the LSHBI and currently have manufacturer's products or will be potential future purchasers of their product(s).
   2. Connect to all subscribers via website.
   3. Alert all subscribers to suggested maintenance and warranty expirations.
   4. Offer extended warranties or product replacement and upgrades.
   5. Alert all subscribers to recalls, product updates and sales opportunities.
   6. Align with product manufacturer's own regional authorized service providers to connect with subscribers.
   7. Connect to subscribers who currently have competitor's products who are no longer in business.
   8. Assist subscribers who currently have competitor's products who are no longer in business.
   9. Convert subscribers who currently have competitor's products who are no longer in business to be future purchasers of recommended alternate manufacturer in website (i.e. Marvin for Weathervane windows).
   10. Identify leveraged sales opportunities due to scalability of LSHBI whose product(s) replacement will be concurrent.
   11. Offer quantity discounting to subscribers within the LSHBI.
   12. Educate subscribers via advertising on website.
   13. Link major product supplier website to subscriber website.
   14. Control manufacturer's message.
   15. Provide green tips, promote sustainable products and best practices.

### For Authorized Service Providers:

1. Identify all subscribers who are part of the LSHBI and currently have products or potential future purchases of products who will benefit from authorized service providers.
2. Connect to all subscribers via the website.
3. Respond to subscriber's requests for maintenance, service and warranty, recall issues.
4. Identify leveraged sales opportunities due to scalability of LSHBI whose product(s) replacement will be concurrent.
5. Offer quantity discounting to subscribers within the LSHBI.
6. Educate subscribers via advertising on the website.
7. Link authorized service provider's internal website to subscriber's website.
8. Assist subscribers on issues concerning competitor's products who are no longer in business.
9. Convert subscribers who have competitor's products who are no longer in business to manufacturer representatives by authorized service provider.

### For Local Subcontractor and Supply Companies:

1. Identify all LSHBI.
2. Connect to all subscribers via website.
3. Offer convenience, discounts and privileges to LSHBI.
4. Identify leveraged sales opportunities due to scalability of LSHBI whose service or product replacement will be concurrent.
5. Offer quantity discounting to subscribers within the LSHBI.
6. Link level 1 vendor website to subscribers within the LSHBI.
7. Participate in internal level 1 vendor website if no vendor website exists.
8. Solicit subscribers via banner advertisement on the website.

For Homeowners Association/Property Managers:
1. Identify all LSHBI.
2. Identify any other neighborhood needs/wants for Community Network (i.e. bulletin board) for LSHBI.
3. Connect to one or more subscribers to inventory home product information.
4. Supply website with all product information on programmed form, including completion date of home.
5. Identify by address all potential subscribers of LSHBI including completion date of each home.
6. Distribute completed website program and register all potential subscribers in LSHBI.
7. Act as website local partner for LSHBI and local vendors to establish, maintain, monitor the program to problem solve issues and maintain relationships.
8. Notify website as to any local nuances and/or opportunities.
9. Transact dues invoicing and payment via Community site.

The data mining engine aggregates and mines data on the site to generate reports for vendors that choose to use this service.

### Resale/Donate/Recycling

The resale, donate and recycling portion of HomeDash™ allows homeowners access to an online marketplace to resell donate or recycle subscriber's products. HomeDash™ may retain a small percentage of each sale as a fee for using the marketplace. The resale/recycling section will operate independently from the rest of the main site. PayPal may be used to help facilitate easy sales between two third-party individuals.

### Refinancing Mortgage Sales

HomeDash™ may partner with mortgage providers to offer refinancing mortgages for homeowners. HomeDash™ subscribers looking to refinance their home will be passed to Lending Tree or an alternative mortgage partner to facilitate a sale. The lending company may pay a fee for the lead, much in the same way a service professional pays for a lead generated and communicated through HomeDash™

### Homeowner/Building Insurance Sales

HomeDash™ may partner with one or more insurance companies to offer homeowners various insurance policies to meet their needs. HomeDash™ may pass off the subscriber to a specific insurance company, and that company may pay a fee for the generated lead. It is logical to expect homeowners to purchase auto insurance with their homeowner's policy. Multi-line discounts, or the discount for having home and auto insurance through the same company, are some of the biggest discounts available to end consumers. Therefore, HomeDash™ should expect to sell a considerable amount of auto policies as well.

Once some history has been established, HomeDash™ may develop its own risk pool, allowing for greater discounts in insurance rates for HomeDash™ homeowners. Risk pools are simply groups of people with a similar risk level. It is the goal of HomeDash™ to show that consumers that are proactive about home maintenance, and organized enough to use HomeDash™, are of a lower risk. This discount will help to drive homeowners to purchase insurance through HomeDash™ and its affiliates.

### Data Users and Providers

HomeDash™ will become a major aggregation of product data, warranties, maintenance and service. This data can and will be used in a wide variety of applications including, but not limited to mailing lists, product performance, service performance, warranty ratings, recalls, rating lists of all kind, etc.

The following products and/or services may be provided by HomeDash™:

### House/Building Products

Manufacturer ads
Authorized service enrollment fee and lead sales
Online purchase
Extended warranty sales
Database sales
Other actions (i.e. insurance)
Pro version upgrade fee
New products/accessories

### Personal Products

Manufacturer ads
Authorized service enrollment fee and lead sales
Online purchase
Extended warranty sale
Database sales
Pro version upgrade fee
New products/accessories

### Trades and Suppliers

Manufacturer ads
Trade/supplier ads
Approved vendor ads
Trade/supplier leads
Approved vendor upgrades

### Financial Transactions

Supplier ads
Approved vendor ads
Supplier leads
Approved vendor upgrades

### Resale and Recycle

Manufacturer ads
Trade/supplier ads
Setup fee
Subscription fee

### Community

Manufacturer ads
Trade/supplier ads
Setup fee
Subscription fee

### Home Automation & Security

Manufacturer ads
Trade/supplier ads
Manufacturer leads
Trade/supplier leads

### Green Upgrades

Manufacturer ads
Trade/supplier ads
Manufacturer leads
Trade/supplier leads

An embodiment of the invention may be implemented on a computer system. The computer system includes a bus or other communication mechanism for communicating information, and a processor coupled with the bus for processing information. The computer system also includes a main memory, such as a random access memory (RAM) or other dynamic storage device, coupled to the bus for storing information and instructions to be executed by the processor. Main memory also may be used for storing temporary variables or other intermediate information during execution of instructions to be executed by the processor. The computer system further includes a read only memory (ROM) or other static storage device coupled to the bus for storing static information and instructions for the processor. A storage device, such as a magnetic disk or optical disk, is provided and coupled to the bus for storing information and instructions.

The computer system may be coupled via the bus to a display, such as a cathode ray tube (CRT), for displaying information to a computer user. An input device, including alphanumeric and other keys, is coupled to the bus for communicating information and command selections to the processor. Another type of user input device is cursor control, such as a mouse, a trackball, or cursor direction keys for communicating direction information and command selections to the processor and for controlling cursor movement on the display. This input device typically has two degrees of freedom in two axes, a first axis (e.g., x) and a second axis (e.g., y), that allows the device to specify positions in a plane.

At least one embodiment of the invention is related to the use of a computer system for implementing the techniques described herein. According to one embodiment of the invention, those techniques are performed by the computer system in response to a processor executing one or more sequences of one or more instructions contained in main memory. Such instructions may be read into main memory from another computer-readable medium, such as a storage device. Execution of the sequences of instructions contained in main memory causes the processor to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing data that causes a machine to operate in a specific fashion. In an embodiment implemented using the computer system, various computer-readable media are involved, for example, in providing instructions to the processor for execution. Such a medium may take many forms, including but not limited to storage media and transmission media. Storage media includes both non-volatile media and volatile media. Non-volatile media includes, for example, optical or magnetic disks. Volatile media includes dynamic memory, such as main memory. Transmission media includes coaxial cables, copper wire and fiber optics, including the wires that comprise a bus. Transmission media can also take the form of acoustic or light waves, such as those generated during radio-wave and infra-red data communications. All such media must be tangible to enable the instructions carried by the media to be detected by a physical mechanism that reads the instructions into a machine.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer-readable media may be involved in carrying one or more sequences of one or more instructions to the processor for execution. For example, the instructions may initially be carried on a magnetic disk of a remote computer. The remote computer can load the instructions into its dynamic memory and send the instructions over a telephone line using a modem. A modem local to the computer system can receive the data on the telephone line and use an infra-red transmitter to convert the data to an infra-red signal. An infra-red detector can receive the data carried in the infra-red signal and appropriate circuitry can place the data on the bus. The bus carries the data to main memory, from which the processor retrieves and executes the instructions. The instructions received by main memory may optionally be stored on the storage device either before or after execution by the processor.

The computer system also typically includes a communication interface coupled to the bus. The communication interface provides a two-way data communication coupling to a network link that is connected to a local network. For example, the communication interface may be an integrated services digital network (ISDN) card or a modem to provide a data communication connection to a corresponding type of telephone line. As another example, communication interface may be a local area network (LAN) card to provide a data communication connection to a compatible LAN. Wireless links may also be implemented. In any such implementation, the communication interface sends and receives electrical, electromagnetic or optical signals that carry digital data streams representing various types of information.

A network link typically provides data communication through one or more networks to other data devices. For example, the network link may provide a connection through a local network to a host computer or to data equipment operated by an Internet Service Provider (ISP). The ISP, in turn, provides data communication services through the world wide packet data communication network now commonly referred to as the “Internet”. The local network and the Internet both use electrical, electromagnetic or optical signals that carry digital data streams. The signals through the various networks and the signals on the network link and through the communication interface, which carry the digital data to and from the computer system, are exemplary forms of carrier waves transporting the information.

Computer system can send messages and receive data, including program code, through the network(s), the network link and the communication interface. In the Internet example, a server might transmit a requested code for an application program through the Internet, ISP, local network and communication interface.

The received code may be executed by the processor as it is received, and/or stored in the storage device, or other non-volatile storage for later execution. In this manner, the computer system may obtain application code in the form of a carrier wave.

### Summary/Overview

This is a critical time in the building industry with the end of the building boom and meteoric rise in building maintenance, service, warranty, recall and new/replacement purchases. A personal website centered around a subscriber's home/building, lifestyle and community is provided while revolutionizing how building and product maintenance, service, warranties and recalls are addressed.

The subscriber is connected to product manufacturers and authorized service providers. Operational aspects of the website include cataloging of products, maintenance specifications, schedules and warranty dates pertaining to the subscriber's home. The subscriber is alerted to suggested maintenance schedules, warranty expirations and product recalls. Authorized service providers and manufacturers are linked to their specific products in the site to address product maintenance, service, warranty and new/replacement products. Subscribers are also provided online links to extend product warranties.

Customization of the subscriber's website is offered to add additional warranted items such as furniture, fixtures, equipment, televisions, home furnishings, lawn and garden products, etc. which also operate through alerts. A local community bulletin board is available to connect the subscriber with other subscribers, community associations, classifieds including resale, donate and recycle.

Additional layers include connectivity to local service providers and retailers, i.e. carpenters, electricians, hardware, paint stores, etc. There are also opportunities for subscribers to link to insurance, mortgage and whole house warranty companies for comparative quotes and subsequent purchase.

Additionally, the site tracks the subscriber's green footprint, a visual display that accumulates points when the subscriber uses the various aspects of the site which promote sustainability. Examples include recycling, use of local trades and suppliers, reading manufacturer green tips, rating service providers and products, etc.

The site also includes a dashboard, a landing page which provides an at-a-glance view using gauges, dials, icons and brief reports on the overall building and product health, providing quick connectivity and information.

Subscribers are additionally incentivized for desired actions through monitored gauges, representing reward points to be exchanged for prizes and discounts.

Scalability is achieved by:
Identifying large homogeneous residential/commercial building inventories built in the last 20 years throughout the United States. Specific building construction products (i.e.—roofing, windows, appliances, etc.) common to each home/building community are identified and include product warranty dates and maintenance schedules. Participating subscribers are provided with free Internet programs which monitor maintenance information and warranties, as well as provide new purchase opportunities through the website.
Engaging large product manufacturers to support the website. The manufacturers have the opportunity to specify regional authorized service providers, controlled messaging and new product updates.
Partnership with developers, builders, superintendents, homeowner associations and residential/commercial property managers to connect to the building subscribers. These groups are given incentives to enlist subscribers.

At least one embodiment of the present invention provides a mechanism to comprehensively manage home product maintenance, service, warranties and future like purchases. The website fills the largest void in the building industry at a critical time in history by connecting the subscriber's product representatives and the community at large.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method of facilitating maintenance, repair and replacement of products within a community of large-scale homogeneous building inventories (LSHBI) or units over a communications network, the method comprising:
providing a database of electronic data at a computer site, the data including:
building product data that uniquely identifies building products common to and contained within each building unit within a LSHBI of subscribing building units;
service provider data that identifies service providers for the building products; and
warranty data that identifies warranties and warranty dates for at least one of the building products and services provided by the service providers; and
analyzing the electronic data to determine whether an action to facilitate maintenance, repair or replacement of at least one of the building products is to be performed.

2. The method as claimed in claim 1, wherein the action includes at least one of adding and modifying data in the database.

3. The method as claimed in claim 1, wherein the electronic data includes rating data that represents ratings of the service providers and wherein the action is removing a rated service provider from the database if the ratings associated with the rated service provider are less than optimal and unacceptable.

4. The method as claimed in claim 1, wherein the electronic data includes tracking data that indicates whether the performance of the building products are less than optimal and unacceptable.

5. The method as claimed in claim 1, wherein the step of analyzing includes determining a substantially common warranty date for one of the building products.

6. The method as claimed in claim 1, wherein the action is generating a lead and communicating the lead to a supplier of goods or services.

7. The method as claimed in claim 1, wherein the step of analyzing is performed to determine whether an original supplier of the building products or services for the building products, remains in the business of supplying the building products or services, respectively, and wherein the action is removing the original supplier from the database and substituting a replacement supplier for the original supplier.

8. The method as claimed in claim 1, wherein the step of analyzing is performed statistically.

9. The method as claimed in claim 1, wherein the building product data includes information or information source identifiers that identify manufacturers or suppliers for the building products commonly contained within each subscribing building unit.

10. The method as claimed in claim 1, wherein the service providers are authorized service providers.

11. The method as claimed in claim 1, wherein the service providers are local service providers.

12. The method as claimed in claim 1, wherein the building product data includes a schedule of maintenance dates for the home products contained within each subscribing building unit.

13. The method as claimed in claim 1, wherein the service suppliers fall into at least one of the categories of: appliances, audio/video, cabinetry, carpentry, closets, countertops, deck, doors, drywall, electrical fixtures, exterior veneers, hardware, heating and cooling systems, insulation, electrical fixtures, fireplaces, flatwork, flooring, foundations, mirrors and glass, painting, patio and paving, plumbing fixtures, security, stairs, roofing and gutters, waterproofing, windows and exterior doors and all furniture, fixtures, and equipment.

14. The method as claimed in claim 1, wherein the building product data includes information or information source identifiers sufficient to enable replacement products to be viewed on a device.

15. The method as claimed in claim 1, wherein the communications network is a computer network and the source identifiers comprise hyperlinks to home pages accessible via the computer network.

16. The method as claimed in claim 1, wherein the communications network is the Internet and the source identifiers comprise hyperlinks to home pages accessible via the Internet.

17. The method as claimed in claim 1, wherein the action is communicating an alert to a device for notifying a warranty expiration for a building product contained within each subscribing building unit.

18. The method as claimed in claim 1, wherein the action is communicating an alert to a device for notifying a maintenance date for a building product contained within each subscribing building unit.

19. The method as claimed in claim 1, wherein the action is communicating an alert to a device for notifying a recall of a building product contained within each subscribing building unit.

20. The method as claimed in claim 1, wherein the action is communicating an alert to a device for notifying a product update for a building product contained within each subscribing building unit.

21. The method as claimed in claim 1, further comprising receiving at the computer site a request from a subscriber to add personal product data and/or furniture, fixtures and equipment data in the database of electronic data, the personal product data and/or furniture, fixtures and equipment data uniquely identifying personal products and/or furniture, fixtures and equipment data of the subscriber and wherein the personal products and/or furniture, fixtures and equipment data may include, but not be limited to, one of the following categories: art and collectibles; automobiles; beauty and health; bedding and bath; clothes and accessories; cell phones; computer and electronics; farm and garden; furniture, fixtures & equipment, general, jewelry and watches; office products; music instruments; recreational vehicles; sporting/exercise; tools and home improvement; toys and games; and video gaming, etc, etc.

22. The method as claimed in claim 1, wherein the computer site is a website.

23. The method as claimed in claim 1, wherein the computer site comprises a database server.

24. The method as claimed in claim 1, wherein the service providers comprise at least one of insurance, mortgage and whole home warranty companies.

25. The method as claimed in claim 1, wherein the building products may include, but not be limited to one of the following categories: appliances, audio/video, cabinetry, carpentry, closets, countertops, deck, doors, drywall, electrical fixtures, exterior veneers, hardware, heating and cooling systems, insulation, electrical fixtures, fireplaces, flatwork, flooring, foundations, mirrors and glass, painting, patio and paving, plumbing fixtures, security, stairs, roofing and gutters, waterproofing, windows and exterior doors and all furniture, fixtures, and equipment.

26. The method as claimed in claim 1, wherein the service providers include companies associated with extending the warranties of the home/building products.

27. The method as claimed in claim 1, wherein the service providers include charities and recyclers of products.

28. The method as claimed in claim 1, further comprising providing electronic community information and a forum at a second computer site for subscribers in a community of subscribers to communicate messages between subscribers or with an association of the community.

29. The method as claimed in claim 28, wherein the community information comprises recent community activity.

30. The method as claimed in claim 1, wherein the home product data includes a recall for a home product contained within each subscribing home/building unit.

31. The method as claimed in claim 1, wherein the home product data includes communication information that allows subscribers to communicate with resellers of products.

32. The method as claimed in claim 1, further comprising monitoring use of the computer site that promotes sustainability by each subscriber and providing a corresponding measurement of the use.

33. The method as claimed in claim 32, wherein the monitored use includes at least one of donating or recycling and use of local service providers.

34. The method as claimed in claim 1, further comprising providing a user interface that allows subscribers to access building product information for products contained within their respective building unit.

35. The method as claimed in claim 1, further comprising receiving a consent to use the electronic data to convert at least one building unit in the community of building units to be part of the community of subscribing building units.

36. A computer system for facilitating maintenance, repair and replacement of products within a community of large-scale homogeneous building inventories (LSHBI) or units over a communications network, the system comprising:
a database of electronic data at a computer site, the data including:
home product data that uniquely identifies building products common to and contained within each housing unit in a community of subscribing building units;
service provider data that identifies service providers for the building products; and
warranty data that identifies warranties and warranty dates for at least one of the building products and services provided by the service providers;
a database server for serving up the database of electronic data to a plurality of I/O devices; and
an engine to analyze the electronic data to determine whether an action to facilitate the maintenance, repair or replacement of at least one building product is to be performed.
